(19) United States
(12) Patent Application Publication
(10) Pub. No.: US 2017/0006636 A1
(43) Pub. Date: Jan. 5, 2017

(54) MULTI-CHANNEL ACCESS METHOD AND APPARATUS

(71) Applicant: HUAWEI TECHNOLOGIES CO., LTD., Shenzhen (CN)

(72) Inventors: Yunbo LI, Shenzhen (CN); Yi LUO, Shenzhen (CN); Peter LOC, Cupertino, CA (US)

(73) Assignee: HUAWEI TECHNOLOGIES CO., LTD., Shenzhen (CN)

(21) Appl. No.: 15/267,061

(22) Filed: Sep. 15, 2016

Related U.S. Application Data
(63) Continuation of application No. PCT/CN2014/073703, filed on Mar. 19, 2014.

(51) Int. Cl. H04W 74/08

(52) U.S. Cl. CPC H04W 74/0816; H04W 84/12

(57) ABSTRACT

Embodiments of the present disclosure relate to a multi-channel access method and apparatus. A first device performs data transmission with a second device on a first reserved channel, and the method includes: identifying, by the first device, whether a non-reserved channel except the first reserved channel is in an idle state; triggering, by the first device, a backoff procedure when the non-reserved channel is in the idle state; sending, by the first device, a channel reservation frame on the non-reserved channel after the backoff procedure ends, where the channel reservation frame is used to enable the first device to use the non-reserved channel as a second reserved channel; and performing, by the first device, data transmission with the second device on the first reserved channel and the second reserved channel.

### CROSS REFERENCE TO RELATED APPLICATIONS

This application is a continuation of International Patent Application No. PCT/CN20141073703, filed on Mar. 19, 2014, which is hereby incorporated by reference in its entirety.

### TECHNICAL FIELD

The present disclosure relates to the field of communications technologies, and in particular, to a multi-channel access method and apparatus.

### BACKGROUND

With rapid evolution of a wireless local area network (Wireless Local Access Network, WLAN for short) standard, increasingly large bandwidth is aggregated in a WLAN system to acquire a higher transmission rate. In the WLAN standard, before data transmission, a station generally reserves a channel of a period of time in advance for the station, where the reserved channel is used for subsequent data transmission of the station. Therefore, bandwidth of the channel reserved by the station determines available bandwidth in an entire subsequent data transmission process.

In conventional art, a specific process of reserving a channel by a station is: when a first device needs to performs data transmission with a second device, the first device monitors a channel; when the first device determines that the channel is an idle channel, the first device triggers a backoff procedure, that is, starts a backoff counter to generate a random number to implement the backoff procedure; every time an idle time of the channel reaches one timeslot (Timeslot), 1 is subtracted from the random number generated by the backoff counter. When the random number generated by the backoff counter is reduced to 0, the first device selects bandwidth of the channel and sends a channel reservation frame on the channel, where the channel reservation frame is used as reservation of the channel by the first device; and the first device performs data transmission with the second device on a reserved channel.

As shown in FIG. 1, a channel with a diagonal box is used to indicate that the channel is a busy channel, and a channel with no diagonal box is used to indicate that the channel is an idle channel. A first device sends a request to send (Request To Send, RTS for short) frame to a second device on an idle primary 40 MHz channel. When the second device receives a channel reservation frame, the second device returns a clear to send (Clear To Send, CTS for short) frame to the first device to reserve a channel. After the first device receives the CTS frame, the first device determines that the second device has reserved the channel, and performs data transmission.

However, the following problem is exposed in a solution in the related art for reserving a channel by a station: when a station is reserving a channel, bandwidth of the channel is determined at one time, and during data transmission of the station, the station can perform data transmission by using only the reserved channel, which causes low channel utilization efficiency and a channel resource waste.

### SUMMARY

Embodiments of the present disclosure provide a multi-channel access method and apparatus, which resolve a problem that a station cannot use an idle non-reserved channel in a data transmission process.

In a first aspect, an embodiment of the present disclosure provides a multi-channel access method, where a first device performs data transmission with a second device on a first reserved channel, and the method includes:

Identifying, by the first device, whether a non-reserved channel except the first reserved channel is in an idle state;

triggering, by the first device, a backoff procedure if the non-reserved channel is in an idle state;

sending, by the first device, a channel reservation frame on the non-reserved channel after the backoff procedure ends, where the channel reservation frame is used to enable the first device to use the non-reserved channel as a second reserved channel; and

performing, by the first device, data transmission with the second device on the first reserved channel and the second reserved channel.

In a first possible implementation manner, the identifying, by the first device, whether a non-reserved channel except the first reserved channel is in an idle state specifically includes:

acquiring, by the first device, a receive power value of the non-reserved channel within a preset time;

determining, by the first device, whether the receive power value is less than a preset power threshold; and

If the receive power value is less than the power threshold, determining, by the first device, that the non-reserved channel is in an idle state; or if the receive power value is greater than or equal to the power threshold, determining, by the first device, that the non-reserved channel is in a busy state.

In a second possible implementation manner, before the identifying, by the first device, whether a non-reserved channel except the first reserved channel is in an idle state, the method further includes:

determining, by the first device, a transmission status of the first device on the first reserved channel; and

when the transmission status of the first device on the first reserved channel is a non-sending state, identifying, by the first device, whether the non-reserved channel is in an idle state.

With reference to the second possible implementation manner of the first aspect, in a third possible implementation manner, the sending, by the first device, a channel reservation frame on the non-reserved channel specifically includes:

when the backoff procedure ends and the transmission status of the first device on the first reserved channel is a sending state, sending, by the first device, the channel reservation frame on the non-reserved channel; and

when the backoff procedure ends and the transmission status of the first device on the first reserved channel is a receiving state, identifying, by the first device, whether the non-reserved channel is in an idle state.

In a fourth possible implementation manner, when the first device is specifically a station STA with no data to send, the sending, by the first device, a channel reservation frame on the non-reserved channel specifically includes:

when the backoff procedure ends and a transmission status of the second device on the first reserved channel is a receiving state, sending, by the STA, the channel reservation frame on the non-reserved channel.

With reference to the first aspect, or the first or the second or the third possible implementation manner of the first aspect, in a fifth possible implementation manner, when the first device is specifically an access point AP, the method further includes:

receiving, by the AP, a first control frame sent by the second device, where the first control frame includes identifier information of a third reserved channel reserved by the second device; and

performing, by the AP, data transmission with the second device on any one of the first reserved channel, the second reserved channel, or the third reserved channel according to the identifier information of the third reserved channel.

With reference to the first aspect, or the first or the second or the third or the fourth possible implementation manner of the first aspect, in a sixth possible implementation manner, when the first device is specifically a station STA, after accessing, by the first device, the second reserved channel, the method further includes:

sending, by the STA, a second control frame to the second device, where the second control frame includes identifier information of the second reserved channel, so that the second device performs data transmission with the STA on the first reserved channel and the second reserved channel according to the identifier information of the second reserved channel.

In a second aspect, an embodiment of the present disclosure provides a multi-channel access apparatus, where the apparatus performs data transmission with a first device on a first reserved channel, and the apparatus includes:

an identification unit, configured to identify whether a non-reserved channel except the first reserved channel is in an idle state;

a triggering unit, configured to trigger a backoff procedure if the non-reserved channel is in an idle state;

a sending unit, configured to send a channel reservation frame on the non-reserved channel after the backoff procedure ends, where the channel reservation frame is used to enable the apparatus to use the non-reserved channel as a second reserved channel; and

a transmission unit, configured to perform data transmission with the first device on the first reserved channel and the second reserved channel.

In a first possible implementation manner, the identification unit is specifically configured to:

acquire a receive power value of the non-reserved channel within a preset time;

determine whether the receive power value is less than a preset power threshold; and

If the receive power value is less than the power threshold, determine that the non-reserved channel is in an idle state; or if the receive power value is greater than or equal to the power threshold, determine that the non-reserved channel is in a busy state.

In a second possible implementation manner, the apparatus farther includes:

a determining unit, configured to determine a transmission status of the apparatus on the first reserved channel; and

the identification unit is specifically configured to: when the transmission status of the apparatus on the first reserved channel is a non-sending state, identify whether the non-reserved channel is in an idle state.

With reference to the second possible implementation manner of the second aspect, in a third possible implementation manner, the sending unit is specifically configured to:

when the backoff procedure ends and the transmission status of the apparatus on the first reserved channel is a sending state, send the channel reservation frame on the non-reserved channel; and

the identification unit is specifically configured to: when the backoff procedure ends and the transmission status of the apparatus on the first reserved channel is a receiving state, identify whether the non-reserved channel is in an idle state.

In a fourth possible implementation manner, when the apparatus is specifically a station STA with no data to send, the sending unit is specifically configured to:

when the backoff procedure ends and a transmission status of the first device on the first reserved channel is a receiving state, send the channel reservation frame on the non-reserved channel.

With reference to the second aspect, or the first or the second or the third possible implementation manner of the second aspect, in a fifth possible implementation manner, when the apparatus is specifically an access point AP, the apparatus further includes:

a receiving unit, configured to receive a first control frame sent by the first device, where the first control frame includes identifier information of a third reserved channel reserved by the first device; and

the access unit is further configured to perform data transmission with the first device on any one of the first reserved channel, the second reserved channel, or the third reserved channel according to the identifier information of the third reserved channel.

With reference to the second aspect, or the first or the second or the third or the fourth possible implementation manner of the second aspect, in a sixth possible implementation manner, when the apparatus is specifically a station STA, the sending unit is further configured to send a second control frame to the first device, where the second control frame includes identifier information of the second reserved channel, so that the first device performs data transmission with the STA on the first reserved channel and the second reserved channel according to the identifier information of the second reserved channel.

In a third aspect, an embodiment of the present disclosure provides a multi-channel access apparatus, where the apparatus performs data transmission with a first device on a first reserved channel, and the apparatus includes:

a network interface;

a processor;

a memory; and

an application program physically stored in the memory, where the application program includes an instruction that may be used to enable the processor to execute the following processes:

Identifying whether a non-reserved channel except the first reserved channel is in an idle state;

triggering a backoff procedure if the non-reserved channel is in an idle state;

sending a channel reservation frame on the non-reserved channel after the backoff procedure ends, where the channel reservation frame is used to enable the apparatus to use the non-reserved channel as a second reserved channel; and

performing data transmission with the first device on the first reserved channel and the second reserved channel.

In a first possible implementation manner, the instruction that is in the application program and that may be used to enable the processor to execute the process of identifying whether a non-reserved channel except the first reserved channel is in an idle state is:

acquiring a receive power value of the non-reserved channel within a preset time;

determining whether the receive power value is less than a preset power threshold; and

If the receive power value is less than the power threshold, determining that the non-reserved channel is in an idle state; or if the receive power value is greater than or equal to the power threshold, determining that the non-reserved channel is in a busy state.

In a second possible implementation manner, the application program further includes an instruction that may be used to enable the processor to execute the following processes:

determining a transmission status of the apparatus on the first reserved channel; and

when the transmission status of the apparatus on the first reserved channel is in a non-sending state, identifying whether the non-reserved channel is in an idle state.

With reference to the second possible implementation manner of the third aspect, in a third possible implementation manner, the instruction that is in the application program and that may be used to enable the processor to execute the process of sending a channel reservation frame on the non-reserved channel is:

when the backoff procedure ends and the transmission status of the apparatus on the first reserved channel is a sending state, sending the channel reservation frame on the non-reserved channel; and

when the backoff procedure ends and the transmission status of the apparatus on the first reserved channel is a receiving state, identifying whether the non-reserved channel is in an idle state.

In a fourth possible implementation manner, when the apparatus is specifically a station STA with no data to send, the instruction that is in the application program and that may be used to enable the processor to execute the process of sending a channel reservation frame on the non-reserved channel is:

when the backoff procedure ends and a transmission status of the first device on the first reserved channel is a receiving state, sending the channel reservation frame on the non-reserved channel.

With reference to the third aspect, or the first or the second or the third possible implementation manner of the third aspect, in a fifth possible implementation manner, when the apparatus is specifically an access point AP, the application program further includes an instruction that may be used to enable the processor to execute the following processes:

receiving a first control frame sent by the first device, where the first control frame includes identifier information of a third reserved channel reserved by the first device; and

performing, data transmission with the first device on any one of the first reserved channel, the second reserved channel, or the third reserved channel according to the identifier information of the third reserved channel.

With reference to the third aspect, or the first or the second or the third or the fourth possible implementation manner of the third aspect, in a sixth possible implementation manner, when the apparatus is specifically a station STA, the application program further includes an instruction that may be used to enable the processor to execute the following process:

sending a second control frame to the first device, where the second control frame includes identifier information of the second reserved channel, so that the second device performs data transmission with the STA on the first reserved channel and the second reserved channel according to the identifier information of the second reserved channel.

Therefore, in the multi-channel access method and apparatus according to the embodiments of the present disclosure, a first device performs data transmission with a second device on a first reserved channel, and at the same time, identifies whether a non-reserved channel is in an idle state; when the non-reserved channel is in an idle state, the first device triggers a backoff procedure and sends a channel reservation frame on the non-reserved channel; the first device uses the non-reserved channel as a second reserved channel and performs data transmission with the second device on the first reserved channel and the second reserved channel. Therefore, after reserving some channels, a station constantly reserves new idle channels in a data transmission process, and performs data transmission by using the reserved channels and the newly reserved idle channels, thereby improving channel utilization efficiency and saving channel resources.

### BRIEF DESCRIPTION OF DRAWINGS

FIG. 1 is a schematic diagram of a channel access mechanism in the related art;

FIG. 2 is a flowchart of a multi-channel access method according to Embodiment 1 of the present disclosure;

FIG. 3 is a schematic diagram of reserving a channel by a device according to an embodiment of the present disclosure;

FIG. 4 is a schematic diagram of continuous channel reservation according to an embodiment of the present disclosure;

FIG. 5 is a sequence diagram of reserving a channel by an access point (AP) according to Embodiment 2 of the present disclosure;

FIG. 6 is a sequence diagram of reserving a channel by a station (STA) according to Embodiment 3 of the present disclosure;

FIG. 7 is a sequence diagram of reserving a channel by a STA according o Embodiment 4 of the present disclosure;

FIG. 8 is a schematic structural diagram of a multi-channel access apparatus according to Embodiment 5 of the present disclosure;

FIG. 9 is a schematic structural diagram of another multi-channel access apparatus according to Embodiment 5 of the present disclosure; and

FIG. 10 is a schematic structural diagram of hardware of a multi-channel access apparatus according to Embodiment 6 of the present disclosure.

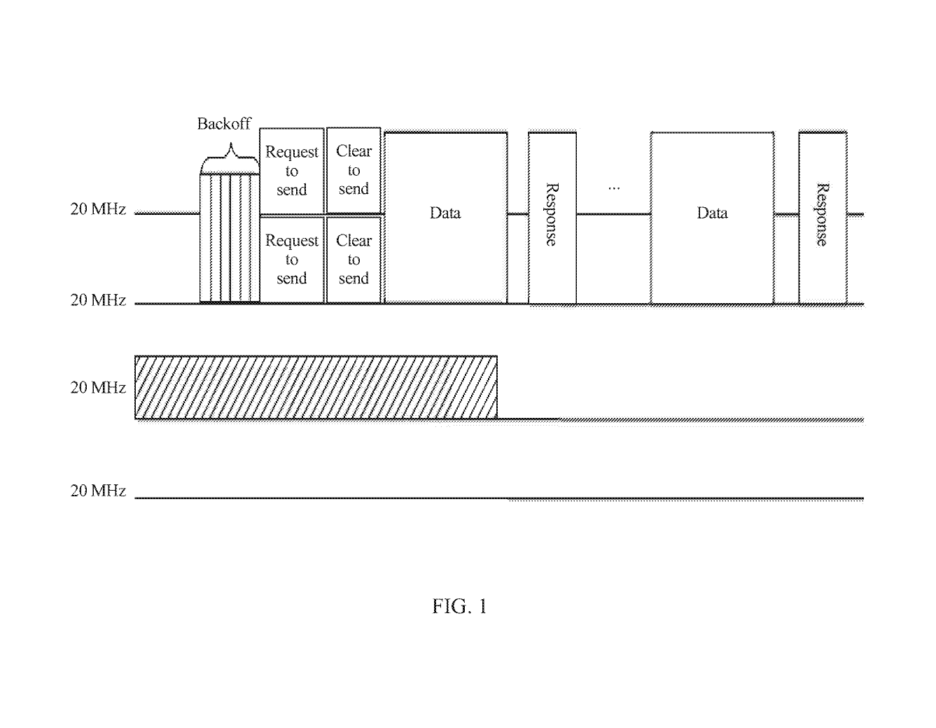

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

For better understanding of the embodiments of the present disclosure, the following uses specific embodiments to provide further explanations and descriptions with reference to the accompanying drawings, and the embodiments constitute no limitation on the embodiments of the present disclosure.

### Embodiment 1

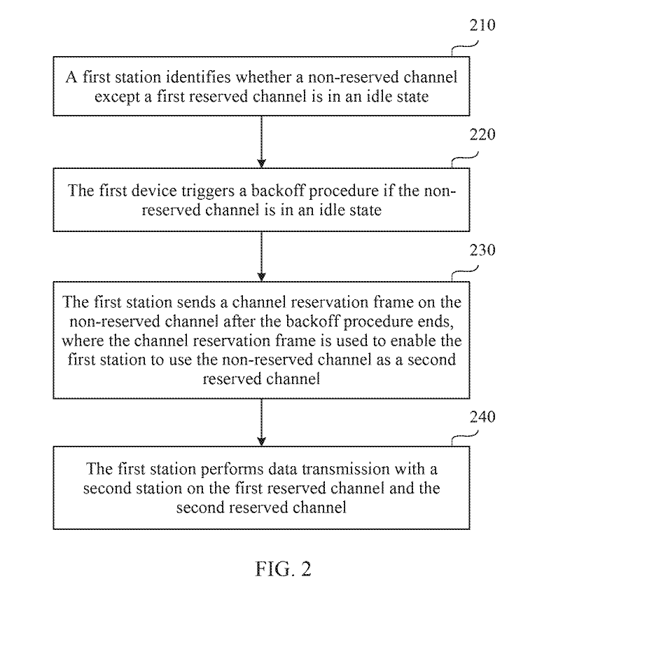

FIG. 2 is used as an example in the following to describe in detail a multi-channel access method provided in Embodiment 1 of the present disclosure. FIG. 2 is a flowchart of the multi-channel access method according to Embodiment 1 of the present disclosure. This embodiment of the present disclosure is executed by a first device or an application module loaded in the first device. As shown in FIG. 2, this embodiment specifically includes the following steps:

Step 210: The first device identifies whether a non-reserved channel except the first reserved channel is in an idle state.

Specifically, before executing this step, the first device performs data transmission with a second device on the first reserved channel. It may be understood that, in this embodiment of the present disclosure, the first device may reserve the first reserved channel for data transmission with the second device by using a channel reservation scheme in the related art, which is not further described herein.

Further, that the first device identifies whether a non-reserved channel except the first reserved channel is in an idle state specifically includes:

acquiring, by the first device, a receive power value of the non-reserved channel within a preset time; determining, by the first device, whether the receive power value is less than a preset power threshold; and if the receive power value is less than the power threshold, determining, by the first device, that the non-reserved channel is in an idle state; or if the receive power value is greater than or equal to the power threshold, determining, by the first device, that the non-reserved channel is in a busy state.

Step 220: The first device triggers a backoff procedure if the non-reserved channel is in an idle state.

Specifically, according to the determining in step 210, the first device triggers the backoff procedure if the non-reserved channel is in an idle state.

Further, the backoff procedure may be specifically implemented in a manner of generating a random backoff number. In an example, the first device starts a backoff counter that is included in the first device, and the backoff counter generates any random number to implement the backoff procedure. It may be understood that, in the backoff procedure, the first device still periodically identifies whether the non-reserved channel is in an idle state, and every time an idle state time of the non-reserved channel is one period of time (the period of time is preset), 1 is subtracted from the random number generated by the backoff counter; if the first device identifies that the non-reserved channel changes from an idle state to a busy state, the backoff counter is suspended, and the backoff counter does not continue to perform the backoff procedure until the first device identifies that the non-reserved channel is in an idle state.

In this embodiment of the present disclosure, any other backoff mechanism that is used to avoid causing collision when multiple stations send data at the same time may further be used in the backoff procedure, for example, a backoff mechanism based on a probability P.

Step 230: The first device sends a channel reservation frame on the non-reserved channel after the backoff procedure ends, where the channel reservation frame is used to enable the first device to use the non-reserved channel as a second reserved channel.

Specifically, the backoff procedure ends when the random number generated by the backoff counter is 0. The first device sends the channel reservation frame on the non-reserved channel in an appropriate time, and the channel reservation frame is used to enable the first device to use the non-reserved channel as the second reserved channel.

The appropriate time specifically refers to a time in which the first device or the second device is in a non-receiving state on the first reserved channel.

Further, the first device may send the channel reservation frame on the non-reserved channel in a broadcasting manner, and the second device that receives the channel reservation frame needs to keep silent on the second reserved channel, or not to perform sending or replying until being scheduled or triggered by the first device. For example, after receiving scheduling from the first device, the second device sends data during being scheduled. For another example, after receiving data from the first device, the second device sends a corresponding reply frame.

Step 240: The first device performs data transmission with the second device on the first reserved channel and the second reserved channel.

Specifically, after the first device completes channel reservation on the non-reserved channel, the first device may perform data transmission with the second device on the first reserved channel and the second reserved channel. Therefore, after reserving some channels, the first device constantly acquires idle channels in a data transmission process, and performs data transmission by using the reserved channels and the acquired idle channels, thereby improving channel utilization efficiency and saving channel resources.

Optionally, before step 210 in this embodiment of the present disclosure, the method further includes a step of determining, by the first device, a transmission status of the first reserved channel. By using this step, the first device can determine the transmission status of the first reserved channel and identify, when the first reserved channel is in a non-sending state, whether the non-reserved channel is in an idle state. Specific steps are as follows:

determining, by the first device, a transmission status of the first device on the first reserved channel; and when the transmission status of the first device on the first reserved channel is a non-sending state, identifying, by the first device, whether the non-reserved channel is in an idle state.

Specifically, the first device determines the transmission status of the first device on the first reserved channel. When the transmission status of the first device on the first reserved channel is a non-sending state, the first device executes step 210. When the transmission status of the first device on the first reserved channel is a sending state, the first device does not execute step 210 and subsequent steps, and the first device continues to determine the transmission status of the first device on the first reserved channel.

In this embodiment of the present disclosure, the non-sending state specifically includes a receiving state and an idle state. The idle state is specifically a neither sending nor receiving state.

It should be noted that, in this embodiment of the present disclosure, it is assumed that the first device has only one radio frequency link within a range of a frequency band, that is, the first device cannot send data on one channel and receive data on another channel at the same time. Therefore, when sending data on the first reserved channel, the first device cannot identify, at the same time on the non-reserved channel, whether the non-reserved channel is in an idle state. Only when the first device is in a receiving state or an idle state on the first reserved channel, the first device can identify, on the non-reserved channel, whether the non-reserved channel is in an idle state. If the first device has multiple radio frequency links, the first device can send and receive data on different channels, and at the same time, identify whether the non-reserved channel is in an idle state. This implementation case may be not limited to the method proposed in this embodiment of the present disclosure, but higher hardware costs are required.

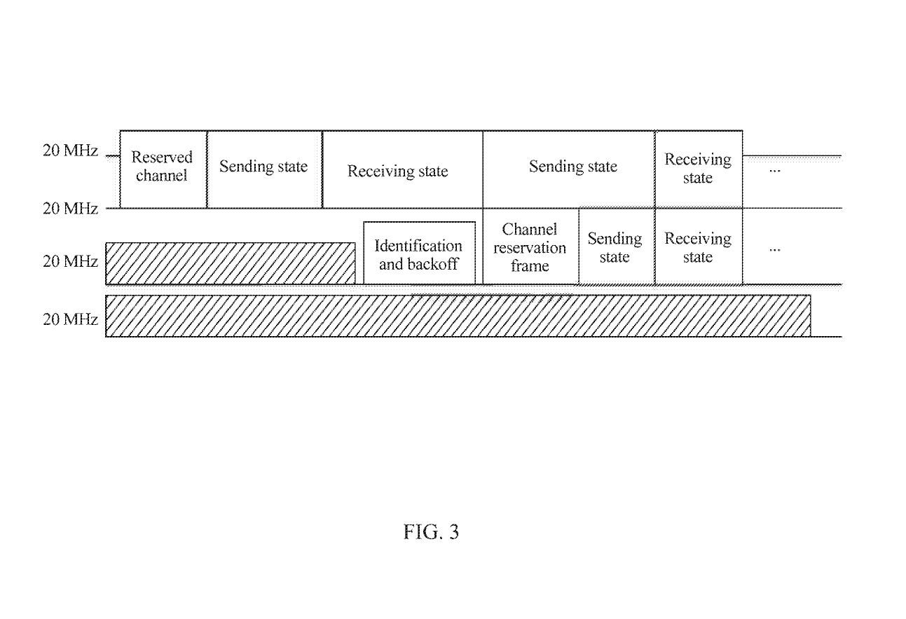

For example, as shown in FIG. 3, FIG. 3 is a schematic diagram of reserving a channel by a device according to an embodiment of the present disclosure. In FIG. 3, a channel with a diagonal box is used to indicate that this channel is a busy channel, and a channel with no diagonal box is used to indicate that this channel is an idle channel. In this embodiment of the present disclosure, when the transmission status of the first device on the first reserved channel is a receiving state, the first device identifies whether the non-reserved channel is in an idle state, and triggers the backoff procedure when the non-reserved channel is in an idle state. When the backoff procedure ends and the transmission status of the first device on the first reserved channel is a sending state, the first device sends the channel reservation frame on the non-reserved channel and reserves the non-reserved channel.

It should be noted herein that, when the first device is specifically a station (station, STA for short) with no data to send and the second device is an access point (Access Point, AP for short), the STA is in a receiving state regardless of whether the AP sends data to another STA on the first reserved channel or another STA sends data to the AP on the first reserved channel. When a transmission status of the AP on the first reserved channel is a receiving state, the STA identifies whether the non-reserved channel is in an idle state, and triggers the backoff procedure when the non-reserved channel is in an idle state. When the backoff procedure ends and the transmission status of the AP on the first reserved channel is a receiving state, the STA sends the channel reservation frame on the non-reserved channel and reserves the non-reserved channel.

Optionally, in this embodiment of the present disclosure, when the first device is specifically an access point AP, the method further includes a step of receiving, by the AP, a first control frame sent by the second device and performing, according to identifier information that is of a third reserved channel and that is included in the first control frame, data transmission with the second device on any one of the first reserved channel, the second reserved channel, or the third reserved channel. By using this step, the first device can perform data transmission with the second device on multiple idle non-reserved channels, thereby improving channel utilization efficiency and saving channel resources. Specific steps are as follows:

receiving, by the AP, the first control frame sent by the second device, where the first control frame includes the identifier information of the third reserved channel accessed by the second device; and

accessing, by the AP according to the identifier information of the third reserved channel, the third reserved channel, and performing data transmission with the second device on any one of the first reserved channel, the second reserved channel, or the third reserved channel.

Specifically, the AP receives the first control frame sent by the second device, where the first control frame includes the identifier information of the third reserved channel accessed by the second device. The AP performs data transmission with the second device on any one of the first reserved channel, the second reserved channel, or the third reserved channel according to the identifier information of the third reserved channel.

In this embodiment of the present disclosure, the second device is a non-AP station, and is specifically a STA. When the first device is an AP and the second device is a STA, the AP and the STA may reserve the non-reserved channel according to a described process of the foregoing step 210 to step 240. A process of reserving the non-reserved channel by the STA is the same as the described process of the foregoing steps, and is not further described herein.

The STA sends the first control frame to the AP, that is, the reserved third reserved channel is assigned or licensed to the AP, and the AP controls or schedules the third reserved channel.

Optionally, in this embodiment of the present disclosure, when the first device is specifically a STA, the method further includes a step of sending, by the STA, a second control frame to the second device so that the second device performs data transmission with the second device on the first reserved channel and the second reserved channel according to identifier information that is of the second reserved channel and that is included in the second control frame. By using this step, the first device can perform data transmission with the second device on multiple idle non-reserved channels, thereby improving channel utilization efficiency and saving channel resources. Specific steps are as follows:

sending, by the STA, the second control frame to the second device, where the second control frame includes the identifier information of the second reserved channel, so that the second device performs data transmission with the STA on the first reserved channel and the second reserved channel according to the identifier information of the second reserved channel.

Specifically, after accessing the second reserved channel, the STA sends the second control frame to the second device, where the second control frame includes the identifier information of the second reserved channel, so that the second device performs data transmission with the STA on the first reserved channel and the second reserved channel according to the identifier information of the second reserved channel.

In this embodiment of the present disclosure, the second device is an AP. When the first device is a STA and the second device is an AP, both the AP and the STA may reserve the non-reserved channel according to a described process of the foregoing step 210 to step 240. A process of reserving the non-reserved channel by the AP is the same as the described process of the foregoing steps, and is not further described herein.

After the STA accesses the second reserved channel, the STA sends the second control frame to the AP, that is, the accessed second reserved channel is assigned or licensed to the AP, and the AP controls and schedules the second reserved channel.

Optionally, in this embodiment of the present disclosure, the first device may reserve channels on multiple channels in an interleaving manner. This manner not only meets an unlicensed spectrum standard but also helps maintain latency of service implementation by using multiple channels.

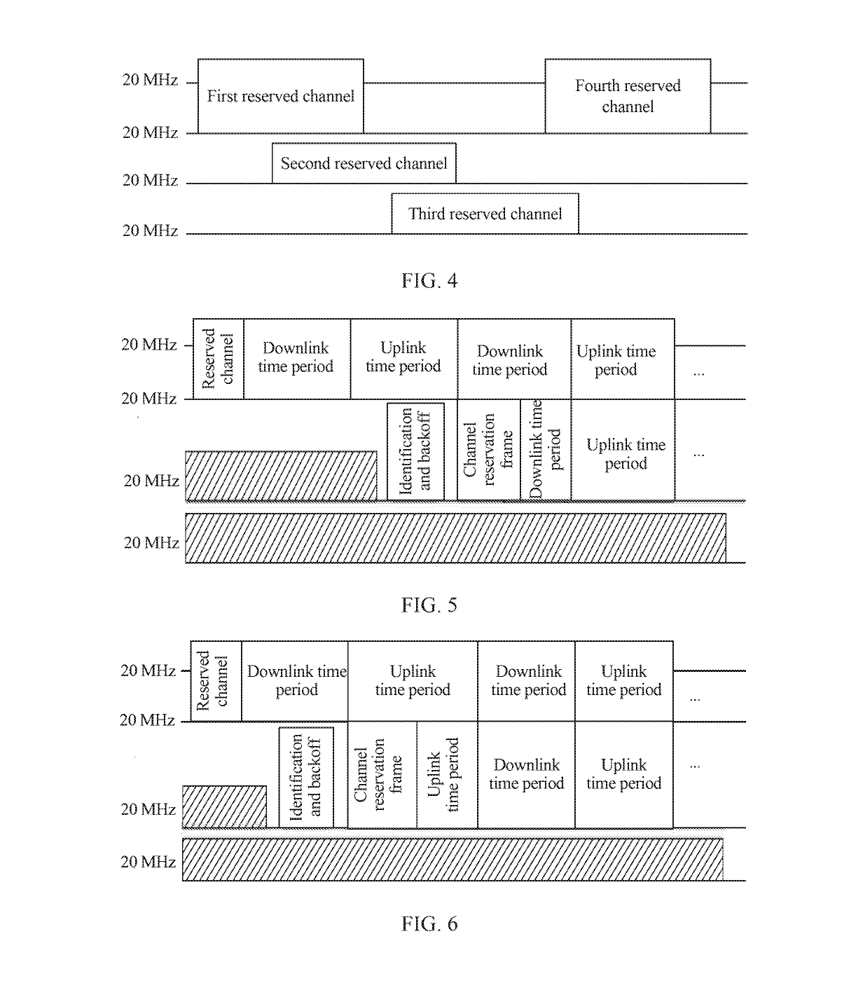

Specifically, as shown in FIG. 4, the first device first successfully reserves the first reserved channel, and performs data transmission by using the first reserved channel. At the same time, the first device performs channel reservation for the second time on the non-reserved channel according to the solution described in the foregoing step 210 to step 240, and accesses the second reserved channel.

Because a starting time at which the first device performs channel reservation for the second time is after a starting time at which the first device performs channel reservation for the first time, according to a limit of a longest time of single channel reservation, an ending time of the second time of channel reservation is also after an ending time of the first time of channel reservation. Therefore, during data transmission on the first reserved channel and the second reserved channel, the first device may continue to perform channel reservation for the third time on another non-reserved channel.

Therefore, according to the multi-channel access method provided in this embodiment of the present disclosure, a first device performs data transmission with a second device on a first reserved channel, and at the same time, identifies whether a non-reserved channel is in an idle state; when the non-reserved channel is in an idle state, the first device triggers a backoff procedure and sends a channel reservation frame on the non-reserved channel; the first device uses the non-reserved channel as a second reserved channel and performs data transmission with the second device on the first reserved channel and the second reserved channel. Therefore, after reserving some channels, a station constantly reserves new idle channels in a data transmission process, and performs data transmission by using the reserved channels and the newly reserved idle channels, thereby improving channel utilization efficiency and saving channel resources.

### Embodiment 2

To facilitate real-time understanding of the present disclosure, the following specific embodiment provides a further explanation and description with reference to the accompanying drawings. The embodiment constitutes no limitation to the embodiments of the present disclosure.

In the foregoing Embodiment 1, the first device is specifically an AP, or the first device is specifically a STA. The following describes in detail a specific working process of the sending, by the first device, a channel reservation frame on the non-reserved channel in step 230 of the foregoing Embodiment 1. In this embodiment of the present disclosure, an example in which the first device is specifically an AP and the second device is specifically a STA is used for detailed description.

The AP performs data transmission with the STA on a first reserved channel. It may be understood that, in this embodiment of the present disclosure, the AP may reserve the first reserved channel for data transmission with the STA by using a channel reservation scheme in the related art, which is not further described herein.

The AP acquires a receive power value of the non-reserved channel within a preset time; the AP determines whether the receive power value is less than a preset power threshold; and if the receive power value is less than the power threshold, the AP determines that the non-reserved channel is in an idle state; or if the receive power value is greater than or equal to the power threshold, the AP determines that the non-reserved channel is in a busy state.

According to the foregoing determining, if the non-reserved channel is in an idle state, the AP triggers a backoff procedure. A working process of the backoff procedure has been described in detail in the foregoing embodiment, and is not described herein.

When a random number generated by a backoff counter is 0, the backoff procedure ends, and the AP determines a transmission status of the AP on the first reserved channel.

When the backoff procedure ends and the transmission status of the AP on the first reserved channel is a sending state, the AP sends the channel reservation frame on the non-reserved channel, so as to ensure that sending and receiving time periods of the AP on the first reserved channel keep consistent with those on a second reserved channel, which is shown in FIG. 5.

When the backoff procedure ends and the transmission status of the AP on the first reserved channel is a receiving state, the AP identifies Whether the non-reserved channel is in an idle state.

In FIG. 5, a channel with a diagonal box is used to indicate that this channel is a busy channel, and a channel with no diagonal box is used to indicate that this channel is an idle channel. In this embodiment of the present disclosure, the receiving state of the AP on the first reserved channel is corresponding to an uplink scheduling time period, and the sending state of the AP on the first reserved channel is corresponding to a downlink scheduling time period.

That is, when the AP is in the uplink scheduling time period, the AP identifies whether the non-reserved channel is in an idle state, and triggers the backoff procedure when the non-reserved channel is in an idle state; when the backoff ends and the AP is in the downlink scheduling time period, the AP sends the channel reservation frame on the non-reserved channel.

After the AP completes channel reservation on the non-reserved channel, the AP performs data transmission with the STA on the first reserved channel and the second reserved channel. Therefore, after reserving some channels, the AP constantly acquires idle channels in a data transmission process, and performs data transmission by using the reserved channels and the acquired idle channels, thereby improving channel utilization efficiency and saving channel resources.

In this embodiment of the present disclosure, the AP further receives a control frame sent by the STA, where the control frame includes identifier information of a third reserved channel reserved by the STA. The AP performs data transmission with the STA on any one of the first reserved channel, the second reserved channel, or the third reserved channel according to the identifier information of the third reserved channel.

In this embodiment of the present disclosure, the STA may reserve the non-reserved channel according to a described process of the foregoing step 210 to step 240. A process of reserving the non-reserved channel by the STA is the same as the described process of the foregoing steps, and is not further described herein.

After the STA reserves the third reserved channel, the STA sends the control frame to the AP, that is, the reserved third reserved channel is assigned or licensed to the AP, and the AP controls or schedules the third reserved channel.

It should be noted that, when the backoff procedure ends, if the AP determines that the AP is still in the uplink scheduling time period, the AP continues to identify, on the non-reserved channel on which the backoff procedure is completed, whether the non-reserved is in an idle state, so as to ensure that the non-reserved channel is in an idle state before the channel reservation frame is sent.

### Embodiment 3

To facilitate real-time understanding of the present disclosure, the following specific embodiment provides a further explanation and description with reference to the accompanying drawings. The embodiment constitutes no limitation to the embodiments of the present disclosure.

In the foregoing Embodiment 1, the first device is specifically an AP, or the first device is specifically a STA. The following describes in detail a specific working process of the sending, by the first device, a channel reservation frame on the non-reserved channel in step 230 of the foregoing Embodiment 1. In this embodiment of the present disclosure, an example in which the first device is specifically a STA and the second device is specifically an AP is used for detailed description.

The STA performs data transmission with the AP on a first reserved channel. It may be understood that, in this embodiment of the present disclosure, the STA may reserve the first reserved channel for data transmission with the AP by using a channel reservation scheme in the related art, which is not further described herein.

The STA acquires a receive power value of the non-reserved channel within a preset time; the STA determines whether the receive power value is less than a preset power threshold; and if the receive power value is less than the power threshold, the STA determines that the non-reserved channel is in an idle state; or if the receive power value is greater than or equal to the power threshold, the STA determines that the non-reserved channel is in a busy state.

According to the foregoing determining, if the non-reserved channel is in an idle state, the STA triggers a backoff procedure. A working process of the backoff procedure has been described in detail in the foregoing embodiment, and is not described herein.

When a random number generated by a backoff counter is 0, the backoff procedure ends, and the STA determines a transmission status of the STA on the first reserved channel.

When the backoff procedure ends and the transmission status of the STA on the first reserved channel is a sending state, the STA sends the channel reservation frame on the non-reserved channel, so as to ensure that sending and receiving time periods of the AP on the first reserved channel keep consistent with those on a second reserved channel, which is shown in FIG. 6.

When the backoff procedure ends and the transmission status of the STA on the first reserved channel is a receiving state, the STA identifies whether the non-reserved channel is in an idle state.

In FIG. 6, a channel with a diagonal box is used to indicate that this channel is a busy channel, and a channel with no diagonal box is used to indicate that this channel is an idle channel. In this embodiment of the present disclosure, the receiving state of the STA on the first reserved channel is corresponding to an uplink scheduling time period, and the sending state of the STA on the first reserved channel is corresponding to a downlink scheduling time period.

That is, when the STA is in the downlink scheduling time period, the STA identifies whether the non-reserved channel is in an idle state, and triggers the backoff procedure when the non-reserved channel is in an idle state; when the backoff ends and the STA is in the uplink scheduling time period, the STA sends the channel reservation frame on the non-reserved channel.

After the STA completes channel reservation on the non-reserved channel, the STA sends a control frame to the AP, where the control frame includes identifier information of the second reserved channel. The STA assigns or licenses the reserved second reserved channel to the AP, and the AP controls or schedules the second reserved channel, so that the AP performs data transmission with the STA on the first reserved channel and the second reserved channel according to the identifier information of the second reserved channel. Therefore, after reserving some channels, the STA constantly acquires idle channels in a data transmission process, and performs data transmission by using the reserved channels and the acquired idle channels, thereby improving channel utilization efficiency and saving channel resources. The control frame may be a frame that is sent independently, or may be included in the channel reservation frame, which is not limited in this patent.

It should be noted that, when the backoff procedure ends, it the STA determines that the STA is still in the downlink scheduling time period, the STA continues to identify, on the non-reserved channel on which the backoff procedure is completed, whether the non-reserved is in an idle state, so as to ensure that the non-reserved channel is in an idle state before the channel reservation frame is sent.

### Embodiment 4

To facilitate real-time understanding of the present disclosure, the following specific embodiment provides a further explanation and description with reference to the accompanying drawings. The embodiment constitutes no limitation to the embodiments of the present disclosure.

In the foregoing Embodiment 1, the first device is specifically an AP, or the first device is specifically a STA. The following describes in detail a specific working process of the sending, by the first device, a channel reservation frame on the non-reserved channel in step 230 of the foregoing Embodiment 1. In this embodiment of the present disclosure, an example in which the first device is specifically a STA with no data to send and the second device is specifically an AP is used for detailed description.

The STA performs data transmission with the AP on a first reserved channel. It may be understood that, in this embodiment of the present disclosure, the STA may reserve the first reserved channel for data transmission with the AP by using a channel reservation scheme in the related art, which is not further described herein.

The STA acquires a receive power value of the non-reserved channel within a preset time; the STA determines whether the receive power value is less than a preset power threshold; and if the receive power value is less than the power threshold, the STA determines that the non-reserved channel is in an idle state; or if the receive power value is greater than or equal to the power threshold, the STA determines that the non-reserved channel is in a busy state.

According to the foregoing determining, if the non-reserved channel is in an idle state, the STA triggers a backoff procedure. A working process of the backoff procedure has been described in detail in the foregoing embodiment, and is not described herein.

When a random number generated by a backoff counter is 0, the backoff procedure ends, and the STA determines a transmission status of the AP on the first reserved channel.

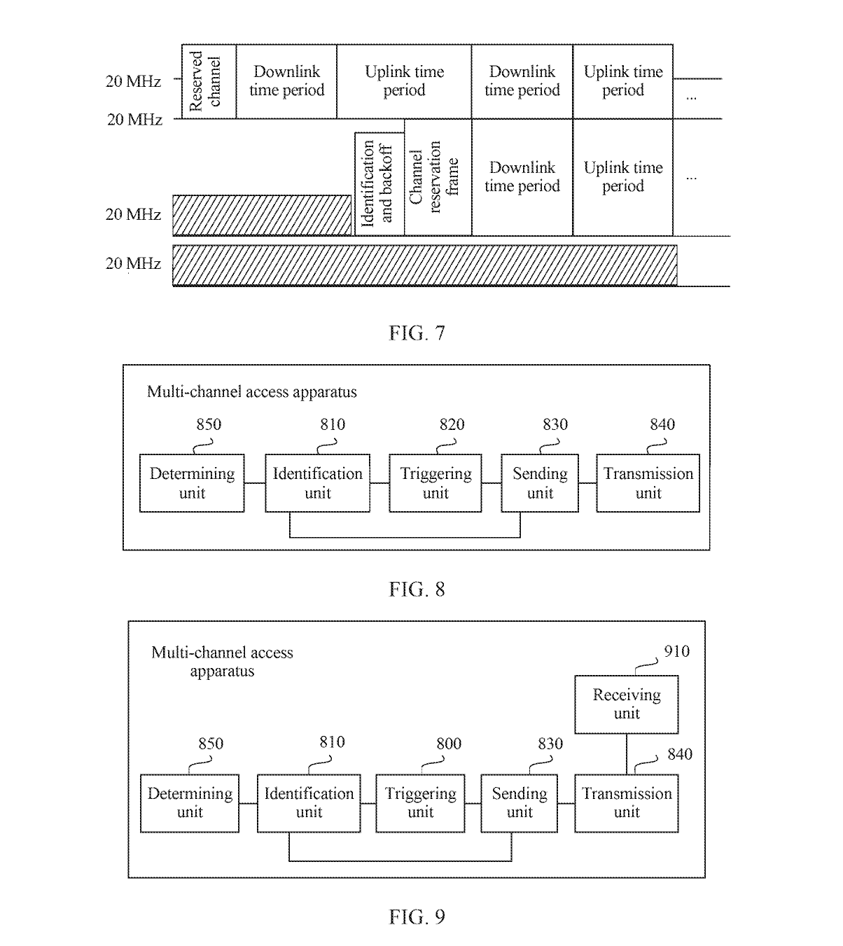

When the backoff procedure ends and the transmission status of the AP on the first reserved channel is a receiving state, the STA sends the channel reservation frame on the non-reserved channel, so as to ensure that sending and receiving time periods of the STA and the AP on the first reserved channel keep consistent with those on a second reserved channel, which is shown in FIG. 7.

In FIG. 7, a channel with a diagonal box is used to indicate that this channel is a busy channel, and a channel with no diagonal box is used to indicate that this channel is an idle channel. In this embodiment of the present disclosure, the receiving state of the AP on the first reserved channel is corresponding to an uplink scheduling time period, and is also corresponding to a sending state (uplink scheduling time period) of the STA on the non-reserved channel.

That is, when the STA is in the uplink scheduling time period, the STA identifies whether the non-reserved channel is in an idle state, and triggers the backoff procedure when the non-reserved channel is in an idle state; when the backoff ends and the AP is in the uplink scheduling time period on the first reserved channel, the STA sends the channel reservation frame on the non-reserved channel. After the STA completes channel reservation on the non-reserved channel, the STA sends a control frame to the AP, where the control frame includes identifier information of the second reserved channel. The STA assigns or licenses the reserved second reserved channel to the AP, and the AP controls or schedules the second reserved channel, so that the AP performs data transmission with the STA on the first reserved channel and the second reserved channel according to the identifier information of the second reserved channel. Therefore, after reserving some channels, the STA constantly acquires idle channels in a data transmission process, and performs data transmission by using the reserved channels and the acquired idle channels, thereby improving channel utilization efficiency and saving channel resources. The control frame may be a frame that is sent independently, or may be included in the channel reservation frame, which is not limited in this patent.

It should be noted that, when the backoff procedure ends, if the STA determines that the STA is still in the downlink scheduling time period, the STA continues to identify, on the non-reserved channel on which the backoff procedure is completed, whether the non-reserved is in an idle state, so as to ensure that the non-reserved channel is in an idle state before the channel reservation frame is sent.

In this embodiment of the present disclosure, the STA may be specifically a terminal that actively reserves a channel after determining that no data needs to be sent on the first reserved channel; or may be a terminal that passively reserves a channel by means of scheduling by the AP.

### Embodiment 5

Accordingly, this embodiment of the present disclosure further provides a multi-channel access apparatus. An implementation structure of the apparatus is shown in FIG. 8, and the apparatus is used to implement the multi-channel access method in the foregoing embodiments of the present disclosure. The apparatus performs data transmission with a first device on a first reserved channel, and the apparatus includes the following units: an identification unit 810 a triggering unit 820, a sending unit 830, and an access unit 840.

The identification unit 810 is configured to identify whether a non-reserved channel except the first reserved channel is in an idle state;

the triggering unit 820 is configured to trigger a backoff procedure if the non-reserved channel is in an idle state;

the sending unit 830 is configured to send a channel reservation frame on the non-reserved channel after the backoff procedure ends, where the channel reservation frame is used to enable the apparatus to use the non-reserved channel as a second reserved channel; and

the transmission unit 840 is configured to perform data transmission with the first device on the first reserved channel and the second reserved channel.

The identification unit 810 is specifically configured to: acquire a receive power value of the non-reserved channel within a preset time;

determine whether the receive power value is less than a preset power threshold; and

if the receive power value is less than the power threshold, determine that the non-reserved channel is in an idle state; or if the receive power value is greater than or equal to the power threshold, determine that the non-reserved channel is in a busy state.

The apparatus further includes: a determining unit 850, configured to determine a transmission status of the apparatus on the first reserved channel; and

the identification unit 810 is specifically configured to: when the transmission status of the apparatus on the first reserved channel is a non-sending state, identify whether the non-reserved channel is in an idle state.

The sending unit 830 is specifically configured to: when the backoff procedure ends and the transmission status of the apparatus on the first reserved channel is a sending state, send the channel reservation frame on the non-reserved channel; and

the identification unit 810 is specifically configured to: when the backoff procedure ends and the transmission status of the apparatus on the first reserved channel is a receiving state, identify whether the non-reserved channel is in an idle state.

When the apparatus is specifically a station STA with no data to send, the sending unit 830 is specifically configured to: when the backoff procedure ends and a transmission status of the first device on the first reserved channel is a receiving state, send the channel reservation frame on the non-reserved channel.

When the apparatus is specifically an access point AP, as shown in FIG. 9, the apparatus further includes: a receiving unit 910, configured to receive a first control frame sent by the first device, where the first control frame includes identifier information of a third reserved channel reserved by the first device; and

the access unit 840 is further configured to perform data transmission with the first device on any one of the first reserved channel, the second reserved channel, or the third reserved channel according to the identifier information of the third reserved channel.

When the apparatus is specifically a station STA, the sending unit 830 is further configured to send a second control frame to the first device, where the second control frame includes identifier information of the second reserved channel, so that the first device performs data transmission with the STA on the first reserved channel and the second reserved channel according to the identifier information of the second reserved channel.

The control frame may be a frame that is sent independently, or may be included in the channel reservation frame, which is not limited in this patent.

Therefore, according to the multi-channel access apparatus provided in this embodiment of the present disclosure, the apparatus performs data transmission with a first device on a first reserved channel, and at the same time, identifies whether a non-reserved channel is in an idle state; when the non-reserved channel is in an idle state, the apparatus triggers a backoff procedure and sends a channel reservation frame on the non-reserved channel; the apparatus uses the non-reserved channel as a second reserved channel and performs data transmission with the first device on the first reserved channel and the second reserved channel. Therefore, after reserving some channels, a station constantly reserves new idle channels in a data transmission process, and performs data transmission by using the reserved channels and the newly reserved idle channels, thereby improving channel utilization efficiency and saving channel resources.

### Embodiment 6

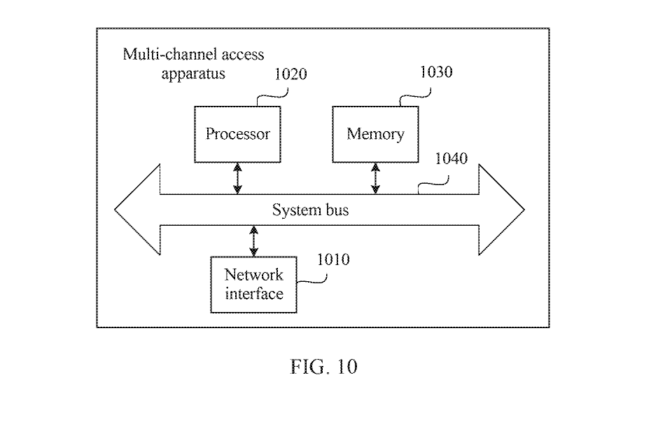

Accordingly, this embodiment of the present disclosure provides a multi-channel access apparatus, which is used to implement the multi-channel access method in the foregoing embodiments. The apparatus performs data transmission with a first device on a first reserved channel, and as shown in FIG. 10, the apparatus includes a network interface 1010, a processor 1020, and a memory 1030. A system bus 1040 is configured to connect the network interface 1010, the processor 1020, and the memory 1030.

The network interface 1010 is configured to interact and communicate with the first device.

The memory 1030 may be a permanent memory such as a hard disk drive and a flash memory. The memory 1030 is configured to store an application program, where the application program includes an instruction that may be used to enable the processor 1020 to access and execute the following processes;

Identifying whether a non-reserved channel except the first reserved channel is in an idle state;

triggering a backoff procedure if the non-reserved channel is in an idle state;

sending a channel reservation frame on the non-reserved channel after the backoff procedure ends, where the channel reservation frame is used to enable the apparatus to use the non-reserved channel as a second reserved channel; and

performing data transmission with the first device on the first reserved channel and the second reserved channel.

Further, the instruction that is in the application program and that may be used to enable the processor 1020 to execute the process of identifying whether a non-reserved channel except the first reserved channel is in an idle state is:

acquiring a receive power value of the non-reserved channel within a preset time;

determining whether the receive power value is less than a preset power threshold; and

if the receive power value is less than the power threshold, determining that the non-reserved channel is in an idle state; or if the receive power value is greater than or equal to the power threshold, determining that the non-reserved channel is in a busy state.

Further, the application program further includes an instruction that may be used to enable the processor 1020 to execute the following processes:

determining a transmission status of the apparatus on the first reserved channel; and

when the transmission status of the apparatus on the first reserved channel is in a non-sending state, identifying whether the non-reserved channel is in an idle state.

Further, the instruction that is in the application program and that may be used to enable the processor 1020 to execute the process of sending a channel reservation frame on the non-reserved channel is:

when the backoff procedure ends and the transmission status of the apparatus on the first reserved channel is a sending state, sending the channel reservation frame on the non-reserved channel; and

when the backoff procedure ends and the transmission status of the apparatus on the first reserved channel is a receiving state, identifying whether the non-reserved channel is in an idle state.

Further, when the apparatus is specifically a station STA with no data to send, the instruction that is in the application program and that may be used to enable the processor 920 to execute the process of sending a channel reservation frame on the non-reserved channel is:

when the backoff procedure ends and a transmission status of the first device on the first reserved channel is a receiving state, sending the channel reservation frame on the non-reserved channel.

Further, when the apparatus is specifically an access point AP, the application program further includes an instruction that may be used to enable the processor 920 to execute the following processes:

receiving a first control frame sent by the first device, where the first control frame includes identifier information of a third reserved channel reserved by the first device; and

performing data transmission with the first device on any one of the first reserved channel, the second reserved channel, or the third reserved channel according to the identifier information of the third reserved channel.

Further, when the apparatus is specifically a station STA, the application program further includes an instruction that may be used to enable the processor 920 to execute the following process:

sending a second control frame to the first device, where the second control frame includes identifier information of the second reserved channel, so that the second device performs data transmission with the STA on the first reserved channel and the second reserved channel according to the identifier information of the second reserved channel.

The control frame may be a frame that is sent independently, or may be included in the channel reservation frame, which is not limited in this patent.

Therefore, according to the multi-channel access apparatus provided in this embodiment of the present disclosure, the apparatus performs data transmission with a first device on a first reserved channel, and at the same time, identifies whether a non-reserved channel is in an idle state; when the non-reserved channel is in an idle state, the apparatus triggers a backoff procedure and sends a channel reservation frame on the non-reserved channel; the apparatus uses the non-reserved channel as a second reserved channel and performs data transmission with the first device on the first reserved channel and the second reserved channel. Therefore, after reserving some channels, a station constantly reserves new idle channels in a data transmission process, and performs data transmission by using the reserved channels and the newly reserved idle channels, thereby improving channel utilization efficiency and saving channel resources.

It is noted that the various units and components in the present disclosure can be implemented using any suitable technology. In an example, a unit can be implemented using circuitry, such as integrated circuit (IC). In another example, a unit can be implemented as a processing circuit executing software instructions.

Persons skilled in the art may further be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. Persons skilled in the art may use different methods to implement the described functions for each particular application, but it should not be considered that the implementation goes beyond the scope of the present disclosure.

Steps of methods or algorithms described in the embodiments disclosed in this specification may be implemented by hardware, a software module executed by a processor, or a combination thereof. The software module may reside in a random access memory (RAM), a memory, a read-only memory (ROM), an electrically programmable ROM, an electrically erasable programmable ROM, a register, a hard disk, a removable disk, a CD-ROM, or any other form of storage medium known in the art.

In the foregoing specific implementation manners, the objective, technical solutions, and benefits of the present disclosure are further described in detail. It should be understood that the foregoing descriptions are merely specific implementation manners of the present disclosure, but are not intended to limit the protection scope of the present disclosure. Any modification, equivalent replacement, or improvement made without departing from the spirit and principle of the present disclosure should fall within the protection scope of the present disclosure.

What is claimed is:

1. A multi-channel access method, wherein a first device performs data transmission with a second device on a first reserved channel, and the method comprises:
identifying, by the first device, whether a non-reserved channel except the first reserved channel is in an idle state;
triggering, by the first device, a backoff procedure when the non-reserved channel is in the idle state;
sending, by the first device, a channel reservation frame on the non-reserved channel after the backoff procedure ends, wherein the channel reservation frame is used to enable the first device to use the non-reserved channel as a second reserved channel; and
performing, by the first device, data transmission with the second device on the first reserved channel and the second reserved channel.

2. The multi-channel access method according to claim 1, wherein the identifying, by the first device, whether the non-reserved channel except the first reserved channel is in the idle state comprises:
acquiring, by the first device, a receive power value of the non-reserved channel within a preset time;
determining, by the first device, whether the receive power value is less than a preset power threshold; and
when the receive power value is less than the power threshold, determining, by the first device, that the non-reserved channel is in the idle state; or when the receive power value is greater than or equal to the power threshold, determining, by the first device, that the non-reserved channel is in a busy state.

3. The multi-channel access method according to claim 1, wherein before the identifying, by the first device, whether the non-reserved channel except the first reserved channel is in the idle state, the multi-channel access method further comprises:
determining, by the first device, a transmission status of the first device on the first reserved channel; and
when the transmission status of the first device on the first reserved channel is a non-sending state, identifying, by the first device, whether the non-reserved channel is in the idle state.

4. The multi-channel access method according to claim 3, wherein the sending, by the first device, the channel reservation frame on the non-reserved channel further comprises:
when the backoff procedure ends and the transmission status of the first device on the first reserved channel is a sending state, sending, by the first device, the channel reservation frame on the non-reserved channel; and
when the backoff procedure ends and the transmission status of the first device on the first reserved channel is a receiving state, identifying, by the first device, whether the non-reserved channel is in the idle state.

5. The multi-channel access method according to claim 1, wherein when the first device is a station (STA) with no data to send, the sending, by the first device, the channel reservation frame on the non-reserved channel comprises:
when the backoff procedure ends and a transmission status of the second device on the first reserved channel is a receiving state, sending, by the STA, the channel reservation frame on the non-reserved channel.

6. The multi-channel access method according to claim 1, wherein when the first device is an access point (AP), the method further comprises:
receiving, by the AP, a first control frame sent by the second device, wherein the first control frame comprises identifier information of a third reserved channel reserved by the second device; and
performing, by the AP, data transmission with the second device on any one of the first reserved channel, the second reserved channel, or the third reserved channel according to the identifier information of the third reserved channel.

7. The multi-channel access method according to claim 1, wherein when the first device is a station (STA), the method further comprises:
accessing, by the first device, the second reserved channel; and
sending, by the STA, a second control frame to the second device, wherein the second control frame comprises identifier information of the second reserved channel, on that the second device performs data transmission with the STA on the first reserved channel and the second reserved channel according to the identifier information of the second reserved channel.

8. A multi-channel access apparatus, wherein the apparatus performs data transmission with a first device on a first reserved channel, and the apparatus comprises:
an identification unit, configured to identify whether a non-reserved channel except the first reserved channel is in an idle state;
a triggering unit, configured to trigger a backoff procedure when the non-reserved channel is in the idle state;
a sending unit, configured to send a channel reservation frame on the non-reserved channel after the backoff procedure ends, wherein the channel reservation frame is used to enable the apparatus to use the non-reserved channel as a second reserved channel; and
a transmission unit, configured to perform data transmission with the first device on the first reserved channel and the second reserved channel.

9. The multi-channel access apparatus according to claim 8, wherein the identification unit is configured to:
acquire a receive power value of the non-reserved channel within a preset time;
determine whether the receive power value is less than a preset power threshold; and
when the receive power value is less than the power threshold, determine that the non-reserved channel is in the idle state; or when the receive power value is greater than or equal to the power threshold, determine that the non-reserved channel is in a busy state.

10. The multi-channel access apparatus according to claim 8, wherein the apparatus further comprises:
a determining unit, configured to determine a transmission status of the apparatus on the first reserved channel; and
the identification unit is configured to: when the transmission status of the apparatus on the first reserved channel is a non-sending state, identify whether the non-reserved channel is in the idle state.

11. The multi-channel access apparatus according to claim 10, wherein the sending unit is configured to:
when the backoff procedure ends and the transmission status of the apparatus on the first reserved channel is a sending state, send the channel reservation frame on the non-reserved channel; and
the identification unit is configured to: when the backoff procedure ends and the transmission status of the apparatus on the first reserved channel is a receiving state, identify whether the non-reserved channel is in the idle state.

12. The multi-channel access apparatus according to claim 8, wherein when the apparatus is a station STA with no data to send, the sending unit is configured to:
when the backoff procedure ends and a transmission status of the first device on the first reserved channel is a receiving state, send the channel reservation frame on the non-reserved channel.

13. The multi-channel access apparatus according to claim 8, wherein when the apparatus is an access point AP, the apparatus further comprises:
a receiving unit, configured to receive a first control frame sent by the first device, wherein the first control frame comprises identifier information of a third reserved channel reserved by the first device; and
the transmission unit is further configured to perform data transmission with the first device on any one of the first reserved channel, the second reserved channel, or the third reserved channel according to the identifier information of the third reserved channel.

14. The multi-channel access apparatus according to claim 8, wherein when the apparatus is a station STA, the sending unit is further configured to send a second control frame to the first device, wherein the second control frame comprises identifier information of the second reserved channel, so that the first device performs data transmission with the STA on the first reserved channel and the second reserved channel according to the identifier information of the second reserved channel.

15. A multi-channel access apparatus, wherein the apparatus performs data transmission with a first device on a first reserved channel, and the apparatus comprises:
a network interface;
a processor;
a memory; and
an application program physically stored in the memory, wherein the application program comprises instructions for causing the processor to execute operations for communication, the operations comprising:
identifying whether a non-reserved channel except the first reserved channel is in an idle state;
triggering a backoff procedure when the non-reserved channel is in the idle state;
sending a channel reservation frame on the non-reserved channel after the backoff procedure ends, wherein the channel reservation frame is used to enable the apparatus to use the non-reserved channel as a second reserved channel; and
performing data transmission with the first device on the first reserved channel and the second reserved channel.

16. The multi-channel access apparatus according to the claim 15, wherein the operation of identifying whether a non-reserved channel except the first reserved channel is in the idle state comprises:
acquiring a receive power value of the non-reserved channel within a preset time;
determining whether the receive power value is less than a preset power threshold; and
when the receive power value is less than the power threshold, determining that the non-reserved channel is in the idle state; or when the receive power value is greater than or equal to the power threshold, determining that the non-reserved channel is in a busy state.

17. The multi-channel access apparatus according to claim 15, wherein the operations further comprise:
determining a transmission status of the apparatus on the first reserved channel; and
when the transmission status of the apparatus on the first reserved channel is in a non-sending state, identifying whether the non-reserved channel is in the idle state.

18. The multi-channel access apparatus according to claim 17, wherein the operation of sending the channel reservation frame on the non-reserved channel comprises:
when the backoff procedure ends and the transmission status of the apparatus on the first reserved channel is a sending state, sending the channel reservation frame on the non-reserved channel; and
when the backoff procedure ends and the transmission status of the apparatus on the first reserved channel is a receiving state, identifying whether the non-reserved channel is in the idle state.

19. The multi-channel access apparatus according to claim 15, wherein when the apparatus is a station (STA) with no data to send, the operation of sending the channel reservation frame on the non-reserved channel comprises:
when the backoff procedure ends and a transmission status of the first device on the first reserved channel is a receiving state, sending the channel reservation frame on the non-reserved channel.

20. The multi-channel access apparatus according to claim 15, wherein when the apparatus is an access point (AP), the operations further comprise:
receiving a first control frame sent by the first device, wherein the first control frame comprises identifier information of a third reserved channel reserved by the first device; and
performing data transmission with the first device on any one of the first reserved channel, the second reserved channel, or the third reserved channel according to the identifier information of the third reserved channel.
